(19) United States
(12) Patent Application Publication
(10) Pub. No.: US 2023/0369709 A1
(43) Pub. Date: Nov. 16, 2023

(54) BATTERY ARRAY THERMAL BARRIER THAT PROVIDES A VENT PATH AND ASSOCIATED METHOD OF VENTING

(71) Applicant: Ford Global Technologies, LLC, Dearborn, MI (US)

(72) Inventors: Bhaskara Rao Boddakayala, Troy, MI (US); Brian Utley, Canton, MI (US); Nihar Kotak, Ashburn, VA (US); James Lawrence Swoish, Northville, MI (US)

(21) Appl. No.: 17/742,469

(22) Filed: May 12, 2022

(51) Int. Cl. H01M 50/342; H01M 50/375; H01M 50/249

(52) U.S. Cl. CPC H01M 50/3425; H01M 50/375; H01M 50/249

(57) ABSTRACT

A battery pack assembly includes battery cells, a thermal barrier adjacent the battery cells, and at least one scored region of the thermal barrier. The scored region is configured to rupture to provide a vent flap that opens to establish a vent path for gas expelled from at least one of the battery cells.

### TECHNICAL FIELD

This disclosure relates generally to a thermal barrier that can provide a path for gas to vent from a battery cell of a battery pack.

### BACKGROUND

A battery pack of an electrified vehicle can include groups of battery cells arranged in one or more battery arrays. From time to time, pressure within one the battery cells can increase and then be released through a vent in that battery cell.

### SUMMARY

In some aspects, the techniques described herein relate to a battery pack assembly, including: a plurality of battery cells; and a thermal barrier adjacent the plurality of battery cells; and at least one scored region of the thermal barrier, the at least one scored region configured to rupture to provide a vent flap that opens to establish a vent path for gas expelled from at least one of the plurality of battery cells.

In some aspects, the techniques described herein relate to a battery pack assembly, wherein the at least one scored region includes a plurality of perforations in the thermal barrier.

In some aspects, the techniques described herein relate to a battery pack assembly, wherein the at least one scored region includes adhesive that holds the vent flap in a closed position.

In some aspects, the techniques described herein relate to a battery pack assembly, wherein the adhesive melts to rupture the at least one scored region and provide the vent flap that can open.

In some aspects, the techniques described herein relate to a battery pack assembly, wherein the vent flap is attached to other areas of the thermal barrier when the vent flap is open.

In some aspects, the techniques described herein relate to a battery pack assembly, wherein the thermal barrier includes woven fibers.

In some aspects, the techniques described herein relate to a battery pack assembly, wherein the thermal barrier includes nonwoven fibers.

In some aspects, the techniques described herein relate to a battery pack assembly, wherein the vent flap can additionally open to provide a vent path for effluents expelled from the at least one of the battery cells.

In some aspects, the techniques described herein relate to a battery pack assembly, further including an enclosure housing the battery cells, the vent path opening to an interior of the enclosure.

In some aspects, the techniques described herein relate to a battery pack assembly, wherein each battery cell within the plurality of battery cells includes a battery cell vent that ruptures to expel the gas from an interior of the battery cell.

In some aspects, the techniques described herein relate to a battery pack assembly, wherein the thermal barrier includes a plurality of scored regions, each of the scored regions is associated with a group of one or more battery cells.

In some aspects, the techniques described herein relate to a battery pack assembly, wherein the group includes four battery cells.

In some aspects, the techniques described herein relate to a method of venting a battery cell, including; scoring a thermal barrier to establish a scored region; rupturing a scored region of the thermal barrier to transition a vent flap of the thermal barrier to an open position, the scored region established by scoring the thermal barrier; and expelling gas from at least one battery cell through an opening in the thermal barrier, the opening provided by the vent flap in the open position.

In some aspects, the techniques described herein relate to a method, further including scoring the thermal barrier by perforating the thermal barrier.

In some aspects, the techniques described herein relate to a method, further including scoring the thermal barrier by slicing the thermal barrier and then adhesively securing the thermal barrier to hold the vent flap in a closed position.

In some aspects, the techniques described herein relate to a method, further including melting the adhesive during the rupturing.

In some aspects, the techniques described herein relate to a method, further including housing the at least one battery cell and the thermal barrier within a battery enclosure.

In some aspects, the techniques described herein relate to a method, wherein the vent flap remains attached to other portions of the thermal barrier when the vent flap is in the open position.

In some aspects, the techniques described herein relate to a method, wherein the thermal barrier is disposes over a vertically upper surface of the at least one battery cell.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a partially expanded view of the battery pack from FIG. 1.

FIG. 3 illustrates a perspective view of a battery array from the battery pack of FIG. 2 with a thermal barrier expanded away from other portions of the battery array.

FIG. 4 illustrates a top view of the battery array of FIG. 3.

FIG. 5 illustrates a top a partially schematic view of the battery pack with the lid removed and annotated to show flow paths through venting channels of the battery pack.

FIG. 6 illustrates a perspective view of a battery cell from the battery array of FIG. 3.

FIG. 7 illustrates a close-up view of an area of the battery array of FIG. 3 with a vent flap of the thermal barrier in an open position.

FIG. 8 illustrates a close-up view of an area of a thermal barrier according to another exemplary aspect of the present disclosure.

### DETAILED DESCRIPTION

A typical traction battery pack includes an enclosure having an interior. Arrays of battery cells are held in the interior along with other components. A thermal event in one or more of the battery cells within of an array can cascade to other battery cells in the battery pack, including battery cells in other battery arrays.

This disclosure details an exemplary thermal barrier that helps to thermally insulate a battery array. The thermal barrier can, when required, providing vent paths to facilitate directing gas from a venting battery cell outside a battery pack without leading to such a cascade.

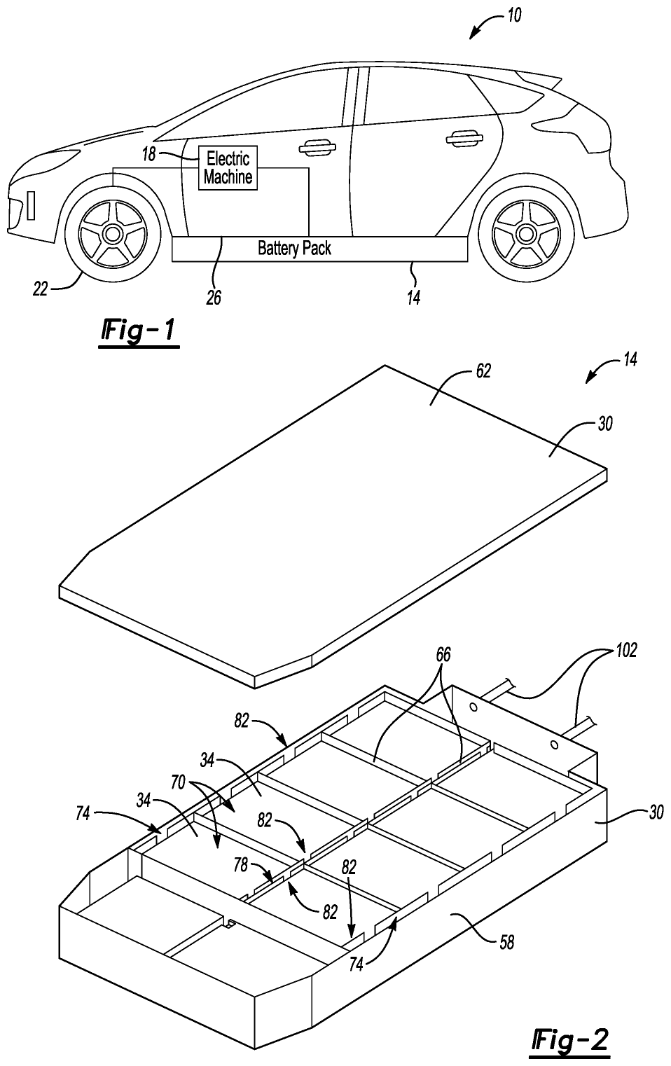

With reference to FIG. 1, an electrified vehicle 10 includes a traction battery pack 14, an electric machine 18, and wheels 22. The battery pack 14 powers an electric machine 18, which converts electric power to torque to drive the wheels 22. The battery pack 14 can be a relatively high-voltage battery.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead, or in addition to, an electric machine. Generally, the electrified vehicle 10 could be any type of vehicle having a traction battery pack.

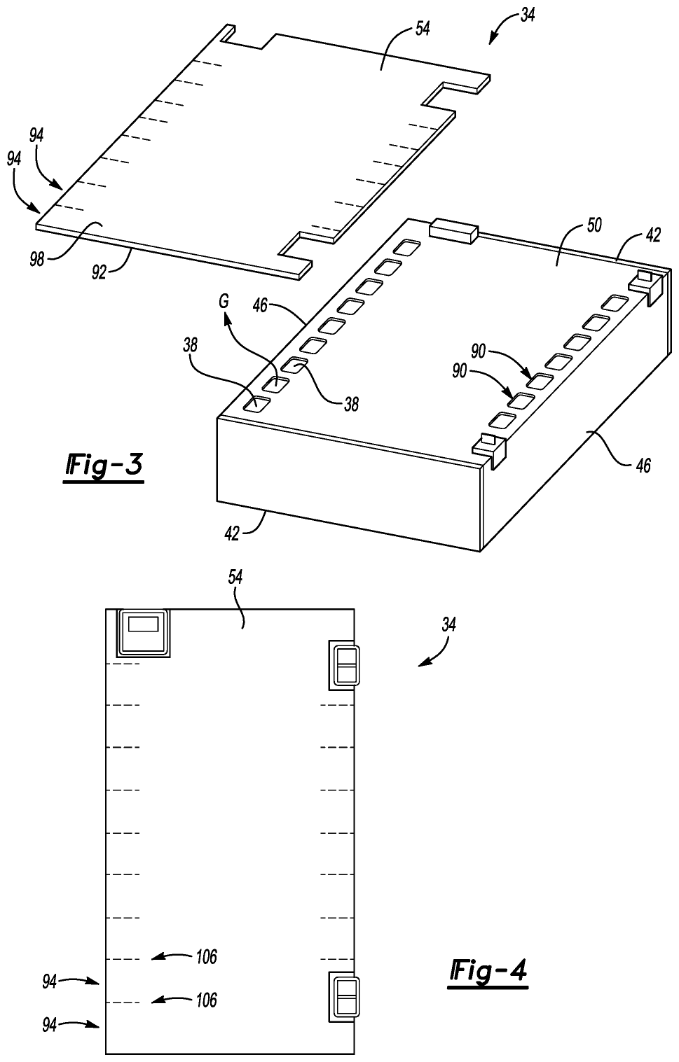

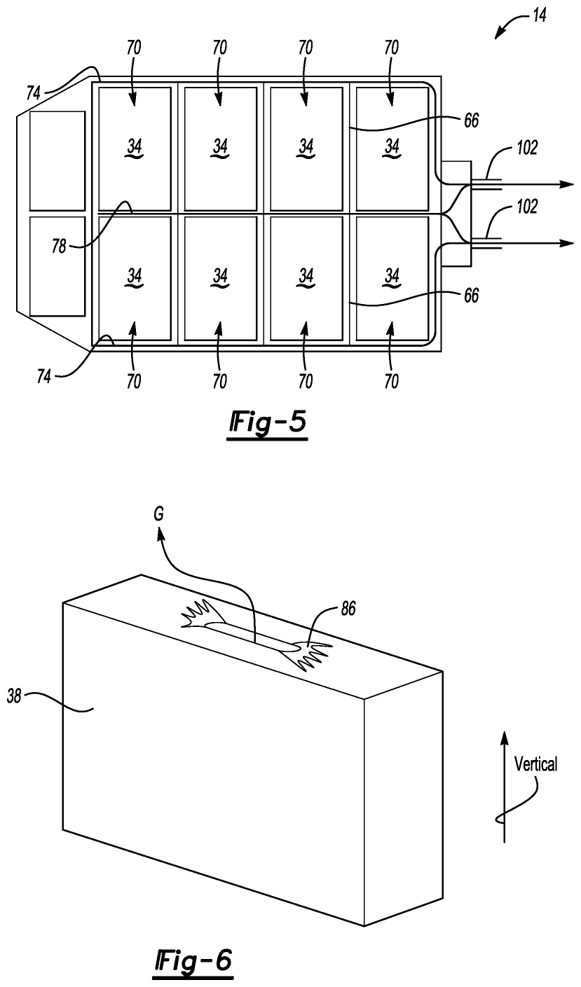

Referring now to FIGS. 2-5 with continuing reference to FIG. 1, the battery pack 14 includes an enclosure 30 that houses, among other things, a plurality of battery arrays 34. In the exemplary embodiment, each of the battery arrays 34 includes a plurality of battery cells 38, endplates 42, side plates 46, a top plate 50, and a thermal barrier 54.

The battery cells 38 can be pouch cells that are compressed between the endplates 42. The side plates 46 can cover the outboard sides of the battery cells 38, The top plate 50 can extend over the vertically upper surfaces of the battery cells 38.

The example thermal barrier 54 is adjacent to the battery cells 38 and is disposed over the vertically upper surface of the top plate 50. Vertical, for purposes of this disclosure, is with reference to ground and an ordinary orientation of the vehicle 10 and battery pack 14 during operation. In other examples, the thermal barrier 54 could be disposed against other surfaces of the battery array 34, such as along an outboard side of the battery array 34.

The thermal barrier 54 in this example, includes a plurality of woven fibers. In another example, the thermal barrier 54 instead or additionally includes nonwoven fibers. The thermal barrier 54 is a thermal insulator. The thermal barrier 54 can be considered a thermal blanket.

The example enclosure 30 includes a tray 58, a lid 62, and dividers 66 that partition an interior of the enclosure 30 into eight array holding areas 70. The example enclosure 30 holds eight individual battery arrays 34. Each of the battery arrays 34 is held within one of the eight array holding areas 70.

In addition to the array holding areas 70, the dividers 66 establish two outboard venting channels 74 and a central venting channel 78. The dividers 66 include openings 82 from the array holding areas 70 to one of the outboard venting channels 74 or the central venting channel 78. The dividers 66 can be reinforced aluminum walls that prevent gas G from moving to other array holding areas 70 and interacting with other battery arrays 34. In this example, the dividers 66 do not provide openings from one of the array holding areas 70 to another array holding area 70.

With reference now to FIG. 6 and continued reference to FIGS. 1-5, the battery cells 38 can each include a battery cell vent 86. From time to time, pressure and temperature within one of the battery cells 38 can increase and rupture the battery cell vent 86. The battery cell 38 can then expel gas G from an interior of the battery cell 38 through the battery cell vent 86. Although a single one of the battery cells 38 is shown as venting, more than one of the battery cells 38 can be venting at the same time. Further, while described as venting gas G, effluents could also be vented to from the battery cells 38 through the battery cell vent 86.

The gas G vented from the battery cell 38 flows from the battery cell 38 through at least one opening 90 in the top plate 50. In this example, a group of the battery cells 38 is configured to vent though one of the openings 90 in the top plate 50. The group can include four individual battery cells 38, each having the respective battery cell vent 86.

From the opening 90, the gas G flows against an underside 92 of the thermal barrier 54. In particular, a scored region 94 of the thermal barrier 54 covers the opening 90 so that gas G flowing from the opening 90 moves against the underside of the scored region 94 of the thermal barrier 54. The thermal barrier 54 includes a plurality of the scored regions 94. Each of the scored regions 94 is associated with, and covers, a respective one of the openings 90.

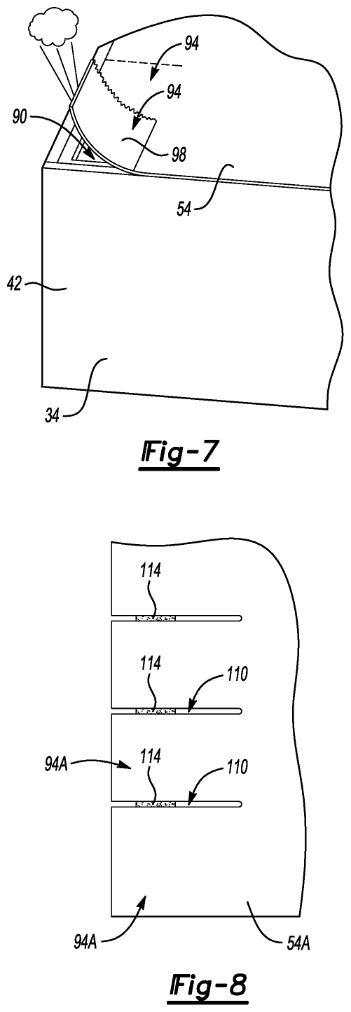

The scored region 94 ruptures when pressure against the underside of the scored region 94 increases above a threshold value. Rupturing the scored region 94 establishes a movable vent flap 98 in the thermal barrier 54 as shown in FIG. 7.

The flow of gas G moving against the vent flap 98 from the opening 90 moves and maintains the vent flap 98 in an open position. This establishes a vent path for the gas G to move past the thermal barrier 54 into the associated array holding area 70. From the array holding area 70, the gas G can move through one of the openings 82 into the central venting channel 78 or one of the outboard venting channels 74.

The vent flap 98 is moves relative to other areas of the thermal barrier when the vent flap 98 moves to the open position. A position of the other areas is substantially maintained which helps to prevent increasing a temperature of battery cells 38 near the battery cell 38 that is venting.

Because the dividers 66 substantially seal the array holding areas 70 relative to each other, the gas G vented from the battery cells 38 does not tend to move from one of array holding areas 70 to another of the array holding areas 70. This helps to ensure that the thermal energy from the battery array 34 having the battery cell 38 that is venting is not cascaded to the battery arrays 34 that do not have battery cells 38 that are venting.

The gas G can move from the central venting channel 78 or the outboard venting channel 74 to one of two venting outlets 102 of the battery pack 14. The venting outlets 102 can then communicate the gas G to an area outside the battery pack 14.

After the gas G is no longer forcing the vent flap 98 to the open position, gravity can cause the vent flap 98 to return to a closed position.

The scored regions 94, in this example, include a plurality of perforations 106 in the thermal barrier 54. When sufficient pressure is applied to the scored region 94, the scored region 94 tears at the perforations 106. Once the thermal barrier 54 is torn at the perforations 106 for one of the scored regions 94, the vent flap 98 for that scored region 94 can move the open position of FIG. 7. The vent flap 98 remains attached to other areas of the thermal barrier 54 when the vent flap 98 is open.

In another example, scored regions 94A are provided by slices, such as the slices 110 shown in the closeup view of an area of the thermal barrier 54A in FIG. 8. The slices 110 fully form vent flaps 98A that can move to an open position. To prevent the vent flaps 98A from moving to the open position until venting is required, an adhesive 114 can hold the vent flaps 98A in the closed position. When opening one or more of the vent flaps 98A is needed due to one or more of the battery cells 38 venting, the pressure associated with venting can rupture the adhesive 114. Thermal energy associated with the venting can instead or additionally melt the adhesive 114 to rupture the scored regions 94A. With the adhesive 114 no longer bonding the vent flaps 98A, the vent flaps 98A are free to move to an open position.

An exemplary method of venting a battery cell can thus include rupturing a scored region of a thermal barrier to transition a vent flap of the thermal barrier to an open position. The scored region can be established by scoring the thermal barrier. With the vent flap in the open position, gas expelled from the battery cell is moved through an opening in the thermal barrier. The opening provided by the vent flap in the open position.

The scoring of the thermal barrier can be accomplished by perforating the thermal barrier. The scoring could instead be accomplished by slicing the thermal barrier to form a complete vent flap, and then adhesively securing the thermal barrier to hold the vent flap in a closed position.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
a plurality of battery cells; and
a thermal barrier adjacent the plurality of battery cells; and
at least one scored region of the thermal barrier, the at least one scored region configured to rupture to provide a vent flap that opens to establish a vent path for gas expelled from at least one of the plurality of battery cells.

2. The battery pack assembly of claim 1, wherein the at least one scored region comprises a plurality of perforations in the thermal barrier.

3. The battery pack assembly of claim 1, wherein the at least one scored region comprises adhesive that holds the vent flap in a closed position.

4. The battery pack assembly of claim 3, wherein the adhesive melts to rupture the at least one scored region and provide the vent flap that can open.

5. The battery pack assembly of claim 1, wherein the vent flap is attached to other areas of the thermal barrier when the vent flap is open.

6. The battery pack assembly of claim 1, wherein the thermal barrier comprises woven fibers.

7. The battery pack assembly of claim 1, wherein the thermal barrier comprises nonwoven fibers.

8. The battery pack assembly of claim 1, wherein the vent flap can additionally open to provide a vent path for effluents expelled from the at least one of the battery cells.

9. The battery pack assembly of claim 1, further comprising an enclosure housing the battery cells, the vent path opening to an interior of the enclosure.

10. The battery pack assembly of claim 1, wherein each battery cell within the plurality of battery cells includes a battery cell vent that ruptures to expel the gas from an interior of the battery cell.

11. The battery pack assembly of claim 1, wherein the thermal barrier includes a plurality of scored regions, each of the scored regions is associated with a group of one or more battery cells.

12. The battery pack assembly of claim 11, wherein the group includes four battery cells.

13. A method of venting a battery cell, comprising;
scoring a thermal barrier to establish a scored region;
rupturing a scored region of the thermal barrier to transition a vent flap of the thermal barrier to an open position, the scored region established by scoring the thermal barrier; and
expelling gas from at least one battery cell through an opening in the thermal barrier, the opening provided by the vent flap in the open position.

14. The method of claim 13, further comprising scoring the thermal barrier by perforating the thermal barrier.

15. The method of claim 13, further comprising scoring the thermal barrier by slicing the thermal barrier and then adhesively securing the thermal barrier to hold the vent flap in a closed position.

16. The method of claim 15, further comprising melting the adhesive during the rupturing.

17. The method of claim 13, further comprising housing the at least one battery cell and the thermal barrier within a battery enclosure.

18. The method of claim 13, wherein the vent flap remains attached to other portions of the thermal barrier when the vent flap is in the open position.

19. The method of claim 13, wherein the thermal barrier is disposes over a vertically upper surface of the at least one battery cell.
